(19) United States
(12) Patent Application Publication
(10) Pub. No.: US 2009/0039036 A1
(43) Pub. Date: Feb. 12, 2009

(54) METHOD AND DEVICE FOR TREATING SLURRY DERIVED FROM A CRACKING OPERATION TO IMPROVE ITS UPGRADING

(76) Inventor: Philippe Roussel, Mere (FR)

Correspondence Address: Muncy, Geissler, Olds & Lowe, PLLC, P.O. BOX 1364, FAIRFAX, VA, 22038-1364, US

(21) Appl. No.: 12/278,936

(22) PCT Filed: Feb. 9, 2007
(86) PCT No.: PCT/FR07/00234

§ 371 Date: Oct. 20, 2008

(30) Foreign Application Priority Data
Feb. 10, 2006 (FR) 06 01195

(51) Int. Cl. B01D 21/26; B04B 3/04

(52) U.S. Cl. 210/787; 210/255; 210/232

(57) ABSTRACT

A method of processing the slurry coming from a cracker by causing solid particles contained in the slurry to settle out, the method consisting of introducing said slurry, on leaving the cracker at a temperature of about 350° C., into the base of a vertical settler having a rotary bowl and an Archimedes' screw, in extracting the clarified phase from the top portion thereof and the solid phase from the bottom portion thereof, and in causing the clarified phase to cool.

The present invention relates to a method and apparatus for clarifying a petroleum product that is viscous at ambient temperature. The product to which the invention applies primarily is the slurry that comes from the base of a catalytic cracker or a steam cracker.

### BACKGROUND OF THE INVENTION

“Slurry” is a petroleum product that leaves a cracker at a temperature of about 350° C., that is cooled by flowing through a plurality of tubular heat exchange stages, and is then stored prior to being upgraded by being incorporated in heavy fuels. Unfortunately, this product carries a load of fine solid particles that come from the catalyst pellets.

The solids in question are usually made of alumina and/or vanadium dioxide. These examples are not limiting: such particles can depend on the nature of each particular catalyst used. These solids have harmful effects in the processing of the slurry at the outlet from the cracker. On cooling, it is found that the tubes become clogged quickly and are subjected to a large amount of wall erosion. It is then necessary to unclog them, leading to a significant loss of operating time during which the cracker is stopped. It is also necessary to remove sediments that have become deposited in the bottom(s) of the storage vessel(s), which become very clogged, requiring removal that is so difficult that it is sometimes better to eliminate the vessel itself completely.

The presence of these particles constitutes a significant burden on the profitability of upgrading the slurry. It is also known that settling on its own during cooling and storage is not sufficient for eliminating all of the particles contained in the slurry. The slurry has a very light load of these particles which are of low density and very fine, all of which properties make it difficult to separate them out under gravity while the slurry is cooling. Unfortunately these particles constitute a source of noxious gases being given off when burning the slurry once it has been incorporated in any fuel. It is probable that such incorporation will be banned in the near future and that products of this type will become even less profitable for upgrading.

### OBJECT OF THE INVENTION

At present there exists an unsatisfied need for clarifying such slurries in a manner that is sufficiently thorough, firstly to eliminate or at least very significantly decrease the frequency with which maintenance operations need to be performed on a catalytic cracker, thereby reducing down time of the refining installation with the corresponding operating losses, and secondly to improve the quality of the purified product so that it can continue to satisfy ever stricter environmental standards concerning the use of petroleum products.

### DESCRIPTION OF THE INVENTION

For this purpose, the invention thus provides firstly a method of processing the slurry coming from a cracker, by settling out solid particles contained in the slurry, the method consisting in introducing said slurry on leaving the cracker, i.e. while at high temperature (about 350° C.), to the base of a vertical settler having a rotary bowl and a central Archimedes' screw conveyor turning at different speeds, in extracting the clarified phase from the top portion thereof and the solid phase from the bottom portion thereof, and in cooling the clarified phase.

The use of a vertical settler for separating the solid and liquid phases of the slurry, unlike natural settling, makes it possible to exert a force field on the product being processed that is 1000 to 10,000 times stronger than the field of gravity on its own, while using equipment that is extremely simple because of the presence of a single bearing for guiding the rotary equipment relative to a stationary support structure.

Performing the separation processing directly at the outlet from the cracker makes a product available that is at high temperature (about 350° C.) and thus of very low viscosity, which is an important condition for obtaining good separation.

The cooling and storage of the liquid phase then takes place in the absence of any solid particles, thereby eliminating any risk of settling out and clogging taking place in the pipes and vessels concerned for cooling and storage purposes.

Subsequent use of the clarified product as an additive to heavy fuel can then continue in spite of the increasing severity of the applicable regulations.

The invention also provides apparatus for implementing the above method, which apparatus is remarkable in that the settler comprising a rotary bowl and a screw is coupled to a hydraulic drive mechanism, e.g. two hydraulic motors, one coupled to the bowl and the other to the Archimedes' screw inside the bowl. The mechanism may be a differential mechanism, e.g. of the kind manufactured by the supplier Viscotherm and including a motor with a first outlet and a secondary outlet at a given transmission ratio. The advantage of hydraulic drive lies in the possibility of cooling the driving oil in a suitable cooling circuit outside the motor unit, e.g. between the oil return and the pump needed for delivering hydraulic energy to the motor unit.

According to another characteristic of the apparatus, the vertical settler is suspended from the floor of a rectangular support structure, which floor subdivides the support into two superposed compartments, each in the form of a box, the bottom box surrounding the settler and some of the various accessories needed for controlling and monitoring its operation, while the top compartment/box is fitted with handling means such as a traveling bridge crane or a pivoting jib crane making it possible to take charge of the settler so as to perform maintenance operations after separating it from the floor and extracting it from its support structure so as to present it at least to outside inspection level with the bottom box.

The apparatus is thus in the form of a container constituting a rectangular tower that can be placed beside a refinery installation that produces such slurries.

It is simple to connect to an existing installation by diverting the slurry-cooling circuit so that it passes through the vertical settler, directly at the outlet from the refinery installation. The dimensions of the container tower are preferably compatible with requirements for transport by road.

Furthermore, in order to reduce significantly the risk of explosion in such apparatus, the container is leaktight and is permanently fed from a source of inert gas, e.g. nitrogen, so as to be at a pressure slightly above atmospheric, thereby preventing any external air from penetrating therein.

Finally, the apparatus could include means for extracting the solid or pasty waste from the bottom of the settler (screw conveyor extraction), and a pump for removing the clarified fluid.

Other characteristics and advantages appear from the following description of an embodiment of the device in accordance with the invention.

### BRIEF DESCRIPTION OF THE DRAWINGS

Reference is made to the accompanying drawings, in which:

FIG. 1 is a diagrammatic elevation view of a container of the invention fitted with a centrifugal settler;

FIG. 2 is a diagrammatic and fragmentary side view of the container; and

FIG. 3 is a diagrammatic plan view of said apparatus.

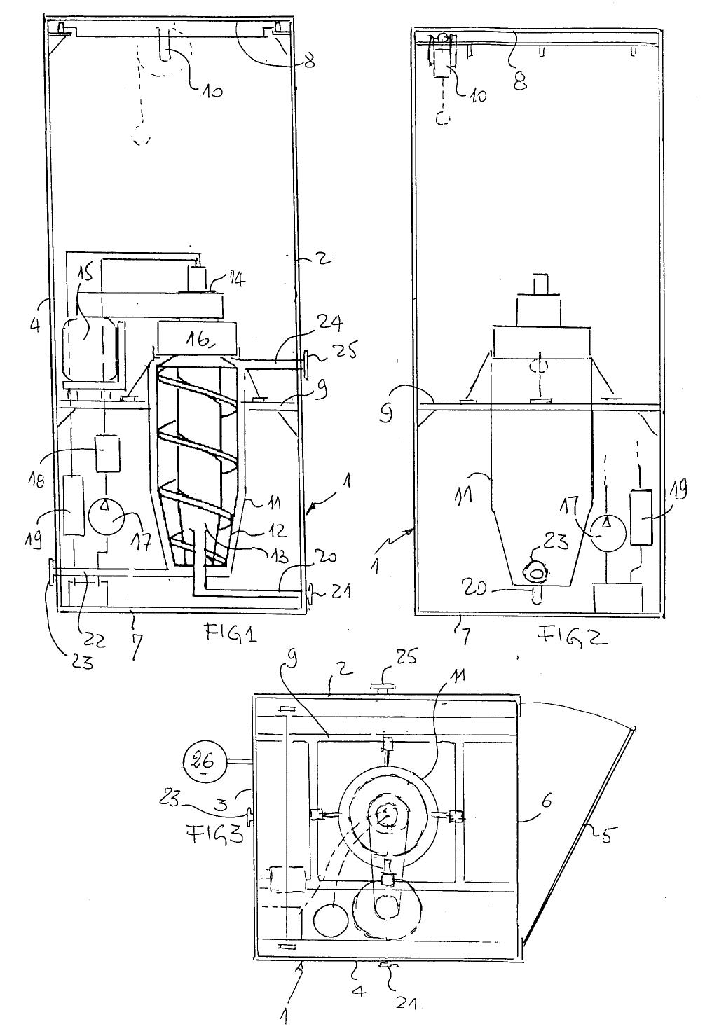

### DETAILED DESCRIPTION OF THE INVENTION

The figures show a container in the form of a rectangular box 1 having outer side walls 2, 3, 4, and 5, the partition 5 being movable to cover and uncover an opening 6 giving access to the volume inside the box. The structure possesses a bottom 7, a ceiling 8, and an intermediate floor 9.

In the top portion, the framework of the box is fitted with hoisting and handling means represented in the form of a traveling bridge crane 10, but which could equally well comprise a pivoting jib crane, e.g. having its vertical upright located in one of the inside corners of the box close to the opening 6.

The floor 10 supports a hollow structure 11 housing the rotary bowl 12 of a vertical centrifugal settler and the central conveyor 13 that is associated therewith. The bowl and the conveyor are suspended from the top of the structure via a top bearing (not shown). As shown in the figure, the bowl is driven in rotation by a pulley 14 driven by a motor 15 and a transmission belt. The inner conveyor 13 (an Archimedes' screw) is driven in rotation by a hydraulic motor 16 having its outer casing rotating with the bowl. This differential bowl/screw drive system is well known: it has been made available on the market under the trade name “Rotordif” by a supplier Viscotherm. Oil is fed to the hydraulic motor via an installation comprising a pump 17, and a filter 18, while fluid return passes via a cooler 19 so as to maintain a suitable temperature in the motor in spite of the settler operating at high temperature.

In a variant that is not shown, the belt drive to the bowl is replaced by another hydraulic motor whose driving oil is likewise cooled vigorously by means of a heat exchanger. The oil for lubricating the bearing supporting the rotary equipment of the settler can also be set into circulation between the bearing and a pump via a cooler. When drive is entirely hydraulic, it is advantageous for the pumps, the filters, and the heat exchangers to be placed in the bottom compartment of the box, situated below the floor 9. The top compartment, above the floor, is then completely unencumbered and makes handling the bowl and the conveyor much easier.

In known manner, the clarified liquid is admitted to the base of the centrifugal settler by a duct 20 possessing a connection flange 21 outside the box for connection to an outlet from the cracker (not shown). The solid or pasty fraction of the inlet liquid is collected in the base of the settler and is conveyed to the outside of the box by a duct 22 provided with a connection flange 23. The clarified liquid is collected from the top of the settler by a duct 24 suitable for connection via an outside connection flange 25 to the installation that exists downstream from the cracker. Under such conditions, it is the clarified liquid that is cooled in this portion of the installation without the drawback of deposition taking place in the pipes or settling in the vessels, both of which are very difficult to clean. In addition to this simplification to maintenance of the installation, the invention makes it possible to obtain much better clarification of the slurry and thus slurry of a quality that is compatible with forthcoming requirements in terms of the solid content of such substances.

Finally, it is specified that the volume inside the box is fed from a source 26 of an inert gas such as nitrogen, at a pressure slightly above atmospheric, so as to maintain an inert atmosphere inside the box where the dangers of explosion and fire are significant, given the high temperature at which the products are processed.

Beyond the connection flanges, the installation includes extraction means adapted to the viscosity of the product being conveyed (a screw transporter for solids or pasts, pumps for the clarified liquid).

The processor device of the invention is particularly advantageous since it can be put into place very quickly, beside a cracker, without any need to make major changes to an existing installation.

In certain applications, it can be advantageous to offset the members for driving the settler together with their control members and to unite them together in an auxiliary container using simple and quick connections between the two containers, connections suitable for being established on site.

1. A method of processing the slurry coming from a cracker by causing solid particles contained in the slurry to settle out, the method consisting of:
introducing said slurry, on leaving the cracker at a temperature of about 350° C., into the base of a vertical settler having a rotary bowl and an Archimedes' screw:
extracting the clarified phase from the top portion;
extracting the solid phase from the bottom portion; and
cooling the clarified phase.

2. An apparatus for implementing the method of claim 1, wherein the rotary bowl and screw settler are coupled to a drive mechanism including at least one hydraulic motor.

3. The apparatus according to claim 2, wherein the vertical settler is suspended from the floor of a support structure in the form of a rectangular container, the floor subdividing the support into two superposed compartments, the bottom compartment surrounding the settler and the various accessories needed for controlling and monitoring its operation, the top compartment being fitted with handling means making it possible to take charge of the settler for maintenance operations so as to separate it from the floor and present it at least to outside inspection level with the bottom compartment by passing through an opening that is closed by a movable side wall of the container.

4. The apparatus according to claim 3, including a source of inert gas for pressurizing the volume inside the container.
